(19) United States
(12) Patent Application Publication
(10) Pub. No.: US 2017/0006408 A1
(43) Pub. Date: Jan. 5, 2017

(54) APPARATUS AND METHOD FOR PROVIDING INTERACTIVE COMMUNICATION SERVICE USING SENSOR NETWORK

(71) Applicant: Electronics and Telecommunications Research Institute, Daejeon (KR)

(72) Inventor: Sun Me KIM, Daejeon (KR)

(73) Assignee: Electronics and Telecommunications Research Institute, Daejeon (KR)

(21) Appl. No.: 15/134,423

(22) Filed: Apr. 21, 2016

(30) Foreign Application Priority Data
Jul. 1, 2015 (KR) 10-2015-0093870

(51) Int. Cl. H04W 4/00; H04H 20/59; H04L 29/08

(52) U.S. Cl. CPC H04W 4/006; H04L 67/12; H04L 67/306; H04H 20/59; H04W 88/16

(57) ABSTRACT

Provided is an apparatus for providing an interactive communication service of devices based on a wireless sensor network (WSN). The apparatus for providing the interactive communication service may include a creator to create a sociality profile including inter-node relationship information for a first service provided through a sensor network including a plurality of nodes, a selector to select at least one first node to participate in the first service among the plurality of nodes based on the sociality profile, and a setter to establish a data transmission relationship based on a kind and function of the at least one first node and to form a first social service group including the at least one first node performing the first service based on the established data transmission relationship.

### CROSS-REFERENCE TO RELATED APPLICATION

This application claims the priority benefit of Korean Patent Application No. 10-2015-0093870, filed on Jul. 1, 2015, in the Korean Intellectual Property Office, the disclosure of which is incorporated herein by reference.

### BACKGROUND

1. Field of the Invention Embodiments relate to a technique for providing an interactive communication service of devices based on a wireless sensor network (WSN), and more particularly to an apparatus and a method for dynamically and flexibly establishing organic relationships in data selection and transmission between a sensor and a device or between devices according to service goals and facilitating a service-customized design according to a service environment change or operator's policy.

2. Description of the Related Art

Generally, a wireless sensor network (WSN) has been designed and used for military applications, radioactivity or fire detection, and various monitoring services for environmental or habitat conditions. In a typical structure of a WSN, all sensing information collected in a sensor field is gathered in a stationary server, such as a gateway, and an operator analyzes and determines monitoring information collected in the server to use for a service.

However, with advancement of Internet of Things (IoT) service and wide spread of intelligent devices, a variety of automated services are required in recent years. In particular, there is a growing need for a sensor network providing a user with a service to change from a function of simply collecting sensing information or transmitting collected information to a stationary server to a structure for providing a “device-to-device interactive IoT service using a mutual organic relationship between sensors and devices according to service goals. In such interactive services, necessary information is exchanged using a mutual organic relationship between a particular sensor and devices selected based on a service goal, not through a gateway or sink in a stationary network, thereby providing an intelligent and automated service in real time. Further, a relationship between a sensor and a device is dynamically and flexibly established according to network environments or operator's policies to provide a plurality of independent services in one local area.

A general WSN has a structure in which all sensing information is transmitted to a designated spot. When a service is provided using the general WSN, a shared model analyzes information collected in a gateway to perform controls or a dedicated model is required for each service. However, the shared model is unable to select sensing information necessary for each service and to dynamically apply a data transmission direction, while the dedicated model has an increase in installation and management costs, making it difficult to actually provide interactive services.

### SUMMARY

According to an aspect, there is provided an apparatus for providing an interactive communication service, the apparatus including a creator to create a sociality profile including inter-node relationship information for a first service provided through a sensor network including a plurality of nodes, a selector to select at least one first node to participate in the first service among the plurality of nodes based on the sociality profile, and a setter to establish a data transmission relationship based on a kind and function of the at least one first node and to form a first social service group including the at least one first node performing the first service based on the established data transmission relationship.

The apparatus may further include a manager configured to manage service information on the plurality of nodes.

The service information may include at least one of kinds, locations, network connection relationships, and associated service lists of the plurality of nodes included in the sensor network.

The manager may periodically notify a gateway in the sensor network of a first identification code for at least one node associated with the first service and a second identification code for the first service based on the service information.

The setter may store a first path for the manager to notify the gateway of the first identification code and the second identification code and may transmit the sociality profile to the first node through a second path that is a reverse path of the first path.

The sociality profile may include at least one of a first identification code for at least one node necessary for the first service, source-sink type information, a data transmission relationship, and a second identification code for the first service.

The setter may generate a gradient representing a data transmission relationship between the first nodes based on the source-sink type information included in the sociality profile.

The setter may update the sociality profile when at least one node is added to or leaves the first social service group.

The setter may remove the first social service group when all nodes in the first social service group leave the first social service group as a result of updating.

The first social service group may support data transmission between the first nodes using at least one of a unicast mode, a multicast mode, and a broadcast mode.

According to another aspect, there is provided an apparatus for providing an interactive communication service, the apparatus including a manager configured to manage service information on at least one of a plurality of nodes included in a sensor network, a creator configured to create a sociality profile of a first service to be provided through the sensor network, a selector configured to select at least one first node to participate in the first service among the plurality of nodes based on the sociality profile, and a setter configured to establish a data transmission relationship based on a kind and function of the at least one first node and to form a first social service group including the at least one first node performing the first service based on the established data transmission relationship.

The service information may include at least one of kinds, locations, network connection relationships, and associated service lists of the plurality of nodes included in the sensor network, and the manager may periodically notify a gateway in the sensor network of a first identification code for at least one node associated with the first service and a second identification code for the first service based on the service information.

The setter may store a first path for the manager to notify the gateway of the first identification code and the second identification code and may transmit the sociality profile to the first node through a second path that is a reverse path of the first path.

According to still another aspect, there is provided a method of providing an interactive communication service through a sensor network including a plurality of nodes by an interactive communication service providing apparatus, the method including creating, by a creator, a sociality profile including inter-node relationship information for a first service provided through the sensor network, selecting, by a selector, at least one first node to participate in the first service among the plurality of nodes based on the sociality profile, and establishing, by a setter, a data transmission relationship based on a kind and function of the at least one first node and forming a first social service group including the at least one first node performing the first service based on the established data transmission relationship.

The crating of the sociality profile may include managing service information including at least one of kinds, locations, network connection relationships, and associated service lists of the plurality of nodes included in the sensor network, and periodically notifying a gateway in the sensor network of a first identification code for at least one node associated with the first service and a second identification code for the first service based on the service information.

The forming of the first social service group may include storing, by the setter, a first path for notifying the gateway of the first identification code and the second identification code and transmitting the sociality profile to the first node through a second path that is a reverse path of the first path.

The sociality profile may include at least one of a first identification code for at least one node necessary for the first service, source-sink type information, a data transmission relationship, and a second identification code for the first service.

The forming of the first social service group may include generating a gradient representing a data transmission relationship between the first nodes based on the source-sink type information included in the sociality profile.

The forming of the first social service group may include updating the sociality profile when at least one node is added to or leaves the first social service group, and removing the first social service group when all nodes in the first social service group leave the first social service group as a result of updating.

The first social service group may support data transmission between the first nodes using at least one of a unicast mode, a multicast mode, and a broadcast mode.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating an interactive communication service providing apparatus according to an example embodiment;

FIGS. 2A and 2B illustrate a service providing mode utilizing a general wireless sensor network (WSN);

FIG. 3 illustrates an interactive communication service providing mode using a social WSN according to an example embodiment;

FIG. 4 illustrates a structure of a social WSN according to an example embodiment;

FIG. 5 illustrates a structure and functions of a social WSN according to an example embodiment;

FIGS. 6A and 6B illustrate a process of establishing a social WSN according to an example embodiment;

FIGS. 7A and 7B illustrate a service subscription process by each node for providing an interactive communication service according to an example embodiment;

FIG. 8 illustrates a process of transmitting a sociality profile for an interactive communication service according to an example embodiment;

FIGS. 9A to 9C illustrate a social gradient binding process for an interactive communication service according to an example embodiment;

FIG. 10 illustrates a configuration of a social WSN for providing a plurality of interactive communication services according to an example embodiment;

FIG. 11 illustrates a process of dynamically configuring a social WSN for supporting mobility for each node according to an example embodiment; and

FIG. 12 is a flowchart illustrating a method of providing an interactive communication service according to an example embodiment.

### DETAILED DESCRIPTION

Hereinafter, example embodiment will be described in detail with reference to the accompanying drawings. However, the present invention is not limited or restricted to these embodiments. Like reference numerals in the drawings refer to the like elements.

Terms used herein are selected among generic terms widely used in consideration of functions in the present invention and may be changed according to customs, intentions of those skilled in the art, or the appearance of new technology.

Further, in particular cases, terms may be selected randomly by the applicant for better understanding and/or convenience of description, which are explained in detail in corresponding descriptions. Thus, terms used herein should be understood not merely by word but based on definitions thereof and overall disclosures set forth herein

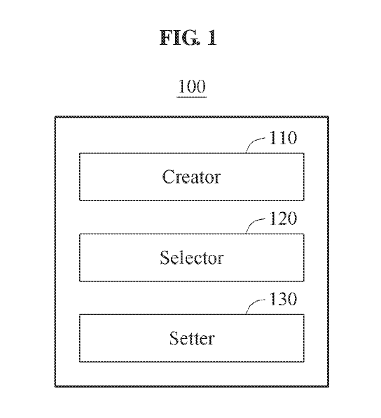

FIG. 1 is a block diagram illustrating an apparatus for providing an interactive communication service according to an example embodiment.

The apparatus for providing the interactive communication service (“interactive communication service providing apparatus”) 100 applies device sociality to a wireless sensor network (WSN) in order to dynamically and flexibly establish an organic relationship in data selection and transfer between a sensor and a device or between devices according to a service goal.

The interactive communication service providing apparatus 100 may include a creator 110, a selector 120, a setter 130, and a manager (not shown). Here, the manager is an optional element, which may be omitted in one embodiment.

The creator 110 may create a sociality profile including inter-node relationship information for a first service provided through the sensor network including a plurality of nodes. Here, the sociality profile may include at least one of a first identification code for at least one node needed to provide the first service, source-sink type information, a data transmission relationship, and a second identification code for the first service. The plurality of nodes may correspond to a plurality of sensors and objects, for example, devices, actuators, or the like, included in the sensor network.

The manager manages service information on the plurality of nodes included in the sensor network. The service information may include at least one of kinds, locations, network connection relationships and associated service lists of the plurality of nodes included in the sensor network. The manager may periodically notify a gateway in the sensor network of the first identification code for the at least one node associated with the first service and the second identification code for the first service based on the service information. Here, the first identification code may denote an identifier (ID) of a node (node ID) associated with the first service among the plurality of nodes included in the sensor network and the second identification code may denote a service ID to identify the first service.

The select 120 may select at least one first node to participate in the first service among the plurality of nodes based on the sociality profile. The selector 120 selects the first node providing the first service using the service information on each node identified through the manager and the sociality profile.

The setter 130 may establish a data transmission relationship based on a kind and function of the at least one first node and form a first social service group including the at least one first node performing the first service based on the established data transmission relationship. The setter 130 may store a first path for the manager to notify the gateway of the first identification code and the second identification code and transmit the sociality profile to the first node through a second path that is a reverse path of the first path. Further, the setter 130 may generate a gradient representing a data transmission relationship and interactive relationship between the first nodes based on the source-sink type information included in the sociality profile.

The setter 130 updates the sociality profile when at least one node is added to or leaves the first social service group. As a result, when all nodes in the first social service group leave the first social service group so that there is no node left, the setter 130 removes the first social service group.

The first social service group supports data transmission between the first nodes using at least one communication mode among a unicast mode, a multicast mode, and a broadcast mode, thereby providing the first service in the sensor network.

The interactive communication service providing apparatus 100 dynamically and flexibly establishes an organic relationship that is service-specific sociality between a sensor and a device or between devices according to a service goal, thereby dynamically controlling sensing data and data flow.

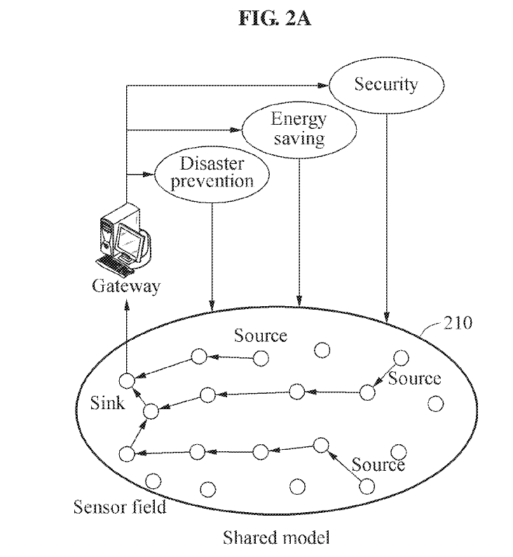

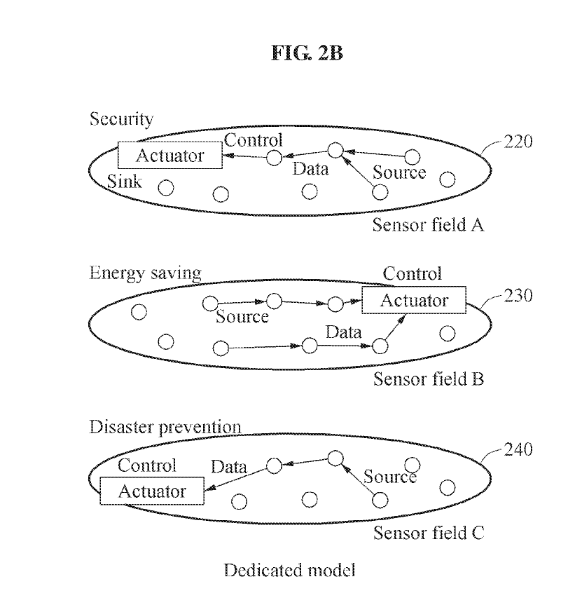

FIGS. 2A and 2B illustrate a service providing mode utilizing a general WSN, wherein FIG. 2A illustrates a shared model in which independent services having different socialities are provided through one sensor network, and FIG. 2B illustrates a dedicated model in which each independent service has a dedicated sensor network.

A general WSN is designed for various environment or habitat monitoring services and has a non-real-time structure in which all sensing information collected by a sensor is transmitted to a designated sink and the designated sink or a gateway server analyzes and utilizes the transmitted sensing information for monitoring. The non-real-time structure makes it difficult for the general WSN to select sensing information necessary for each service goal or sociality or to dynamically apply a transmission direction of sensing information.

In the shared model in FIG. 2A, one sensor field 210 is established to provide a security service, an energy saving service, and a disaster prevention service. In the shared model, sensing information collected through a source node and a sink node is transmitted to a gateway in a fixed direction regardless of each service goal and is analyzed and controlled by the gateway, thereby providing a service.

In the dedicated model in FIG. 2B, a service is provided through independent dedicated sensor fields 220, 230, and 240 established for respective service goals. For example, a sensor field 220 for a security service, a sensor field 230 for an energy saving service, and a sensor field 240 for a disaster prevention service are separately established in the same space and actuators are operated to set up a source node, a sink node and data transmission directions thereof necessary for each service goal to provide a service.

The shared model has difficulty in ensuring interactivity between a sensor and devices included in the sensor network, and the dedicated model involve installation and management of an independent sensor network for each service to cause a cost increase, thus having limitations in providing immediate and continuous interactive services.

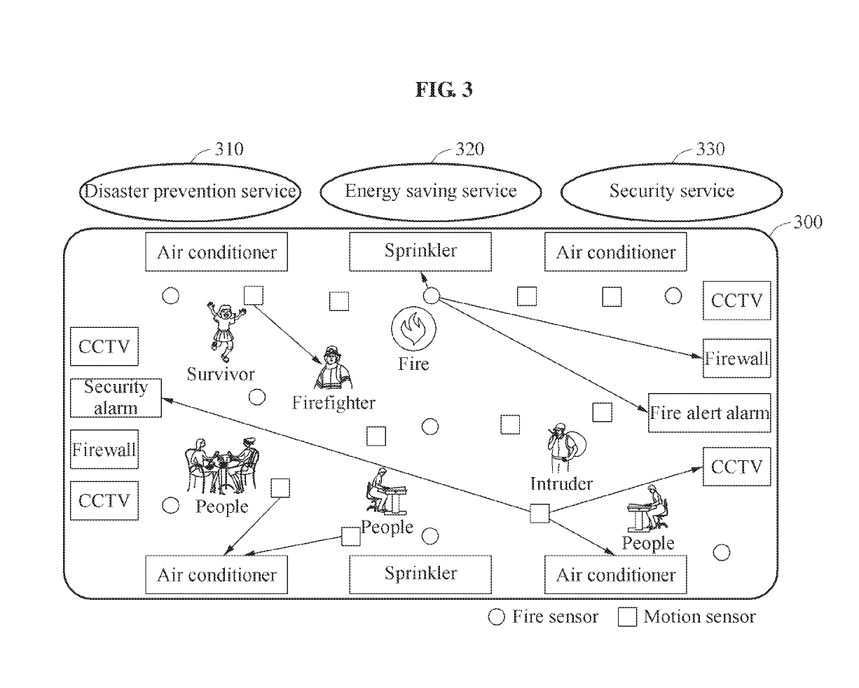

FIG. 3 illustrates an interactive communication service providing mode using a social WSN according to an example embodiment.

Wide spread of Internet of Things (IoT) service technology and intelligent devices enable a variety of automated services in recent years. To this end, a WSN is changing from a conventional structure of simply collecting and transmitting sensing information to a stationary server to a structure of establishing a mutual organic relationship between sensors and devices according to a service goal and providing an immediate “device-to-device interactive IoT service.” In such interactive services, necessary information is exchanged using a mutual organic relationship between a particular sensor and devices selected based on a service goal to provide an intelligent and automated service in real time, in which a plurality of independent services having different socialities may coexist in one local area.

To provide all of a disaster prevention service 310, an energy saving service 320, and a security service 330 in a smart building space 300 in FIG. 3, an independent sociality may be formed for a goal of each service and a mutual organic relationship between a sensor and devices set up based on a sociality by each service may be used. For example, when a fire sensor detects that a fire breaks out in the smart building space 300, the fire sensor transmits fire sensing information to a sprinkler, a fire alarm, and a firewall associated with the disaster prevention service 310, so that the sprinkler discharges water to the fire, the fire alarm immediately rings an alarm bell, and the firewall is controlled to quickly block the fire. Further, when a motion detector detects a movement of a survivor in the fire, the motion detector directly transmits location information on the survivor to a firefighter on the site to quickly rescue the survivor.

In the energy saving service 320, a motion sensor in the smart building space 300 transmits sensing information, such as information on a number or locations of people, to an air conditioner to adjust wind speeds or directions of the air conditioner, thereby efficiently managing energy in the building. In the security service 330, when a motion sensor in the smart building space 300 detects movements during a security operation time, the motion sensor transmits sensing information to a security alarm to immediately to call up a security agency and controls recording through a closest CCTV to a motion-detected location. Further, through continuous interactions between the motion sensor and the CCTV in the smart building space 300, a recording angle may be adjusted according to a movement of an intruder to accurately track the intruder.

The interactive communication service providing apparatus 100 forms independent sociality for each service goal and dynamically uses a mutual organic relationship between a sensor and devices set up based on sociality by each service, thereby providing an immediate and automated service.

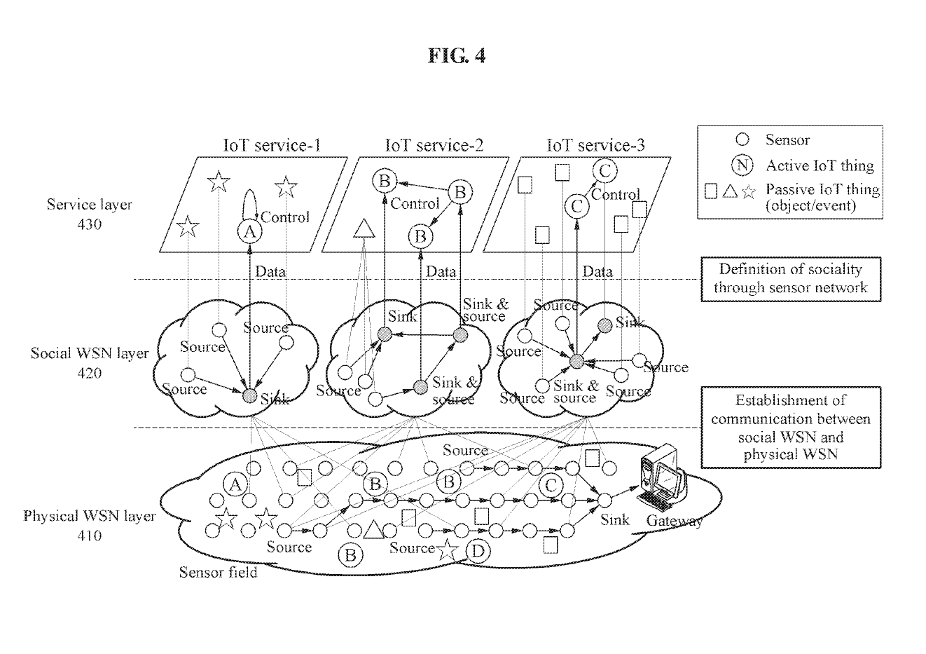

FIG. 4 illustrates a structure of a social WSN according to an example embodiment.

A sensor network, established to provide a device-to-device interactive IoT service in a particular local area, may include a physical WSN layer 410, a social WSN layer 420, and a service layer 430. Here, the local area may refer to a space where a sensor or devices are installed to interact with each other, for example, a factory, a building, a hospital, a downtown hotspot, or the like.

First, the physical WSN layer 410 performs functions specific to a general WSN. The physical WSN layer 410 includes a sensor serving as a source of data collected and transmitted for providing a service, a sink in which collected information is gathered, and a gateway to generally control and manage the WSN. In the physical WSN layer 410, all sensors form one network as in the general WSN, each sensor has a fixed function, and data is transmitted from a stationary source node to a stationary sink node in a data-centric communication mode. The physical WSN layer 410 transmits control information and serves as an actual communication network in order to configure a social WSN for providing various independent services.

The social WSN layer 420 provides an independent social WSN for each service. A sensor node included in the social WSN may be determined based on locations of objects, for example, devices and actuators, associated with each service and a function of the sensor node may be determined as a source or sink node based on functions of the objects. Accordingly, in the social WSN layer 420, a data transmission direction may be dynamically and automatically determined according to sociality of each service. The social WSN layer 420 may be understood as an overlay WSN established over the physical WSN layer 410, which is a network generated and modified automatically and dynamically by service relationships between objects associated with each service. In the social WSN layer 420, objects associated with each service may operate using a communication mode, such as unicast, multicast and broadcast modes, according to a service goal by a service goal-centric communication mechanism.

The service layer 430 is a layer where the device-to-device interactive IoT service is actually provided. The service layer 430 includes specific objects providing each service. Each service is defined by independent sociality by service, that is, objects selected according to a service goal, functions of the selected objects, and an organic relationship, such as a data transmission relationship, between objects. In the service layer 430, the objects may perform own functions using data transmitted through the social WSN layer 420. For example, passive objects (passive IoT things), such has temperature, a fire and a movement, are detected by a sensor and processed via the physical WSN layer 410 and the social WSN layer 420, and active objects (active IoT things), such as a smartphone, a notebook computer and a CCTV, may be controlled based on sociality of a service associated with each object.

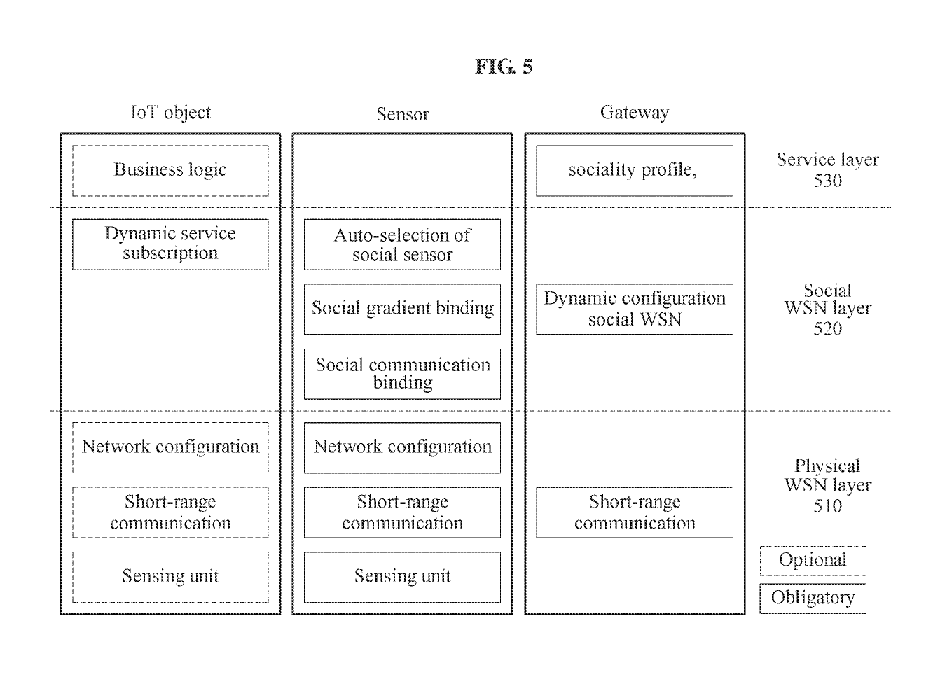

FIG. 5 illustrates a structure and functions of a social WSN according to an example embodiment.

A gateway, a sensor, and objects, which form a WSN, perform own functions based on sociality by each service goal in a physical WSN layer 510, a social WSN layer 520, and a service layer 530 in order to provide an interactive service.

First, in the physical WSN layer 510, a network for actually providing the interactive service is configured. The physical WSN layer 510 may be configured to include a gateway installed in a local area as a sink, all sensors, and objects and performs functions specific to a general WSN. When the physical WSN is configured, a sensor is selected which identifies locations of objects associated with the interactive service and participates in a social WSN based on a node relationship, for example, a data transmission relationship or source-sink relationship, between the objects, and a function thereof is determined In the physical WSN, service control information may be exchanged between the objects, the sensor, and the gateway to determine a data transmission direction between sensors in the social WSN. Further, the physical WSN may provide a short-range communication function and a sensing unit function so that the service control information for identifying the locations of the objects and the sensor and allowing each sensor to autonomously determine an own function and a data transmission direction is transmitted to the gateway as the sink. Topology of the physical WSN including the gateway as a sink may be established by various methods, which needs to enable all sensors to be accessible and the network to flexibly operate with a data transmission path for providing a service being automatically reconfigured in case of dynamic entry/withdrawal/movement of an object or a network disorder.

Meanwhile, a service operator creates a sociality profile of the service in the gateway, which is associated with the service layer 530, in order to provide the interactive service. The sociality profile is a file to define sociality as an organic relationship between objects according to a service goal, which may specify an ID of a service to be provided, IDs of objects associated with the service, functions of the objects as a source or sink, and data transmission relationships between the objects. Based on the sociality profile, a sensor to participate in a social WSN configured for providing the service may be selected and a function and a data transmission relationship of each selected sensor may be determined Further, to simultaneously provide different kinds of independent services through a WSN established in a particular local area, the operator may create one sociality profile for each service, thereby configuring and operating a plurality of independent social WSNs.

In the social WSN layer 520, the social WSN for providing the interactive service is dynamically configured based on the created sociality profile. To this end, in the social WSN layer 520, the social WSN may be dynamically configured in the gateway via dynamic service subscription of the objects associated with the service, auto-selection of social sensors by the sensor and binding a social gradient. Further, a social communication binding process is performed through the configured social WSN to provide a data transmission mode suitable for the goal and characteristics of the service.

The objects forming the WSN periodically publish an ID of the service which the objects participate in and IDs of the objects in the network, thereby automatically subscribing to the service and the social WSN for providing the service. Dynamic service subscription of the objects enables reorganization of the locations of the objects in the sensor network and connection of the objects to each other for the service. Further, to participate in different kinds of services, objects publish differentiated IDs of the services so that one object or sensor may simultaneously participate in independent social WSNs for a plurality of services. Here, when the object is an active thing, the object autonomously publishes the service ID and the ID of the object. When the object is a passive thing, such as an object or event, the service ID and the ID of the object may be detected and published by a sensor. Data, which is information including the service ID and the object ID, published by the object or sensor is transmitted to the gateway as the sink according to the topology of the physical WSN. The objects periodically perform dynamic service subscription to deal with a change by a movement of an object or a sensor network disorder in real time, thereby dynamically apply the change to the social WSN.

During a process of transmitting data published by the objects to the gateway in the WSN, social sensors to participate in the social WSN for providing the service are automatically selected based on the sociality profile and the published data. For example, sensors located on a network path from the object to the gateway are sensors connecting the objects associated with the service, which may be selected to participate in the social WSN. The selected sensors may store service subscription information, such as a service ID and an object ID published by an object to the network, of objects associated with each service and information on a previous sensor on the network path, thereby automatically retrieve locations of objects by service and connection relationships between sensors. Further, the gateway receives the service subscription information from the objects and then transmits the sociality profile associated with the service via the network, which may be transmitted to the selected sensors along a reverse path of the network path on which the service subscription information is transmitted.

The selected social sensors automatically generate a social gradient defining a data transmission relationship for the service using the sociality profile transmitted from the gateway so as to enable data-centric communication without exchanging additional data. A social gradient between objects and/or sensors may be bound according to a series of rules based on source-sink types and data transmission relationships of the respective objects included in the sociality profile so that the selected social sensors and objects transmit data suitable for each service goal. For example, when a previous sensor transmitting service subscription information of an object as a source node is the same as a previous sensor transmitting service subscription information of an object as a sink node, a gradient is not generated. However, when a previous sensor transmitting service subscription information of an object as a source node is different from a previous sensor transmitting service subscription information of an object as a sink node, a gradient from the previous sensor associated with the source node to the previous sensor associated with the sink node may be generated based on an ID of the object as the source node. Through a process of generating a gradient, a data flow direction between social sensors for providing each service may be determined, and one independent social WSN for the service may be configured based on the data flow direction.

When there is a change of an object or sensor associated with the service, the configured social WSN applies the change to continue the service. For example, when at least one object associated with a particular service first joins a sensor network and publishes service subscription information, a new social WSN is generated, topology of which may be modified based on a change whenever another object joints the service. Further, when existing objects change locations or leave the network, the topology and data transmission direction of the social WSN are modified based on a change. When all objects associated with the service leave the network, the social WSN may be automatically removed. Such a process of dynamically configuring a social WSN is automatically performed without operator involvement or a separate hardware change.

The social WSN may support data transmission between objects in various modes, such as a unicast mode, a multicast mode, and a broadcast mode, according to goals and characteristics of each service. Further, when the physical WSN does not support any data transmission mode, a communication binding function between the physical WSN layer 510 and the social WSN layer 520 may be performed in the social WSN so that various modes of data transmission between objects may be supported to provide the service. For example, when a source-node sensor transmits multicast data to a sink-node sensor in the social WSN, the social WSN performs communication bounding to receive the multicast data and to transmit three pieces of unicast data to three sink-node sensors.

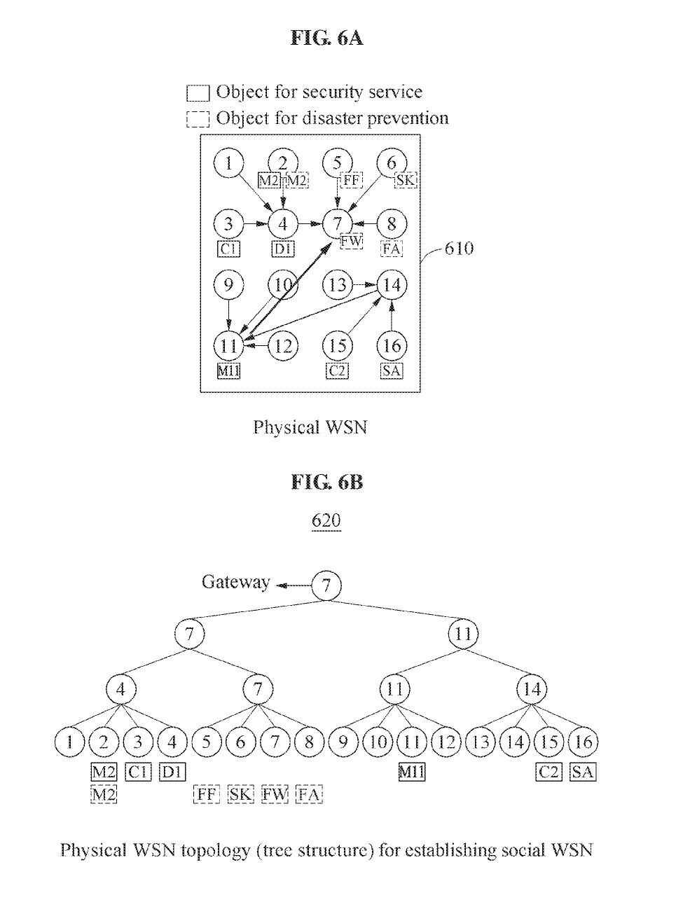

Specific examples of providing an interactive service using a WSN will be described in detail with reference to FIGS. 6A to 11.

FIGS. 6A and 6B illustrate a process of establishing a social WSN according to an example embodiment, which is a process of disposing social WSNs for providing two independent services using a WSN structure in a particular local area that is a smart building.

FIG. 6A illustrates a physical WSN established in the smart building, and FIG. 6B illustrates WSN topology for establishing social WSNs to provide two independent services in the smart building.

Assuming that a physical WSN including 16 sensors is established in the smart building, topology of the physical WSN may be represented as a tree structure in FIG. 6B according to locations or connection relationships between the sensors.

Referring to FIGS. 6A and 6B, objects performing a security service include motion sensor M2 at node 2, CCTV-1 C1 at node 3, door sensor D1 at node 4, motion sensor M11 at node 11, CCTV-2 C2 at node 15, and security alarm SA at node 16. Objects performing a disaster prevention service include motion sensor M2 at node 2, firefighter FF at node 5, sprinkler SK at node 6, firewall FW at node 7, and fire alarm FA at node 8.

A network manager may create a sociality profile based on a goal or characteristics of a service to be provided and store the sociality profile in a gateway within the network. For the security service, a sociality profile including information of ‘Service ID: Security service,’ ‘Object IDs: M2, M11, C1, C2, D1, SA,’ and ‘Relationship: Source (M2)-sink (C1), source (D1)-sink (C1, SA), source (M11)-sink (C2)’ may be created. Likewise, for the disaster prevention service, a sociality profile including information of ‘Service ID: Disaster prevention service,’ ‘Object IDs: M2, FF, FW, SK, FA,’ and ‘Relationship: Source (M2)-sink (FF), source (SK)-sink (FF, FW, FA)’ may be created and transmitted to the gateway.

In the WSN, the objects and sensors operate according to each service goal based on the sociality profiles. For example, in the security service, when motion sensor M2 at node 2 or door sensor D1 at node 4 detects an intruder, CCTV-1 C1 at node 3 starts recoding and door sensor D1 at node 4 calls up a security agency through security alarm SA at node 16. Further, when motion sensor M11 at node 11 detects a motion, CCTV-2 C2 at node 15 starts recording.

In the disaster prevention service, when sprinkler at node 6 detects fire smoke, firefighter FF connected to node 5 is notified, firewall FW at node 7 is shut down, and fire alarm FA at node 8 is operated. Further, when motion sensor M2 at node 2 detects a movement of a survivor, information may be transmitted to firefighter FF at node 5 to rescue the survivor.

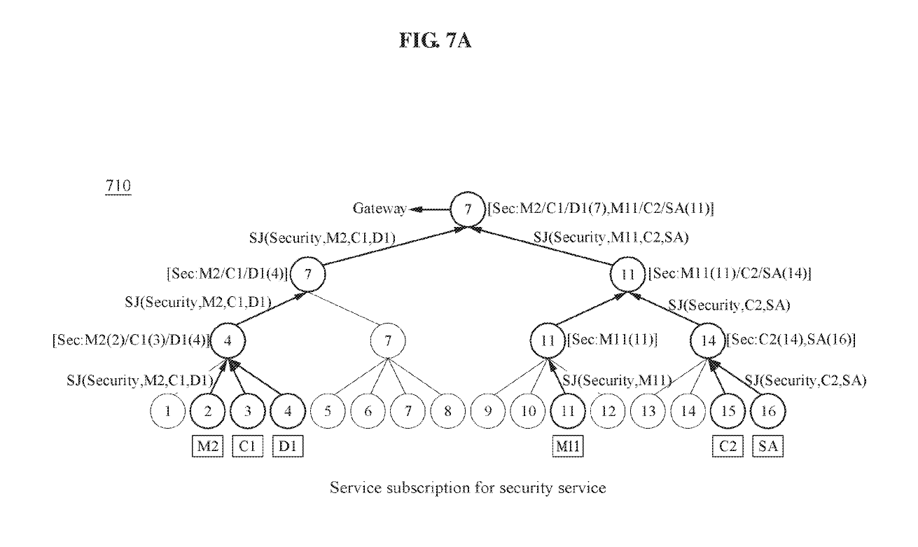

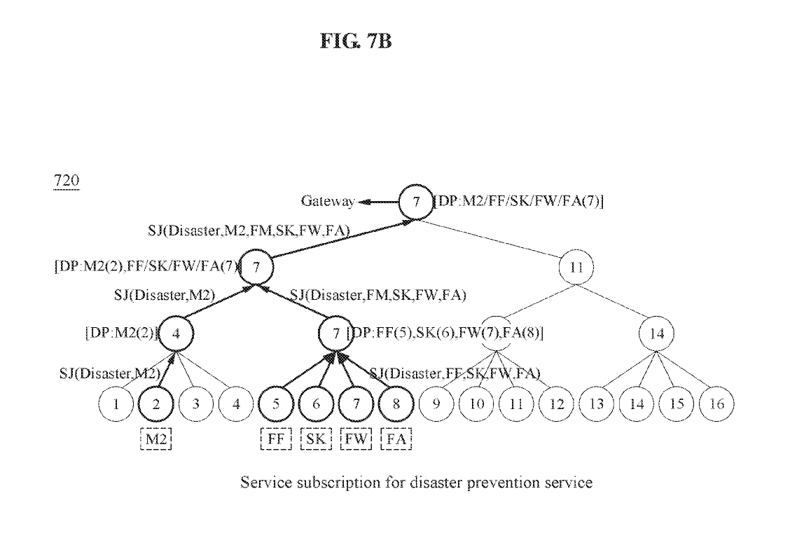

FIGS. 7A and 7B illustrate a service subscription process by each node for providing an interactive communication service according to an example embodiment.

When objects included in a WSN are turned on to be connected to the network, the objects periodically publish an ID of a service in which the objects are to participate and IDs of the objects in the network. FIG. 7A illustrates a path 710 on which service subscription information on a security service is transmitted to a gateway in the WSN, and FIG. 7B illustrates a path 720 on which service subscription information on a disaster prevention service is transmitted to the gateway in the WSN.

Sensors disposed on the paths on which the objects transmit the service subscription information to the gateway in the WSN store service subscription information, such as a service ID and an object ID, of objects associated with each service and information on a previous sensor transmitting the service subscription information.

In FIG. 7A, door sensor D1 at node 4 stores motion sensing information M2 received from node 2 and CCTV information C1 received from node 3 in association with the security service. Likewise, in FIG. 7B, door sensor D1 at node 4 stores firefight information FF received from node 5, sprinkler information SK received from node 6, firewall information FW received from node 7, and fire alarm information FA from node 8 in association with the disaster prevention service. In the WSN, sensors for connecting objects according to each service goal may be automatically selected through the service subscription process.

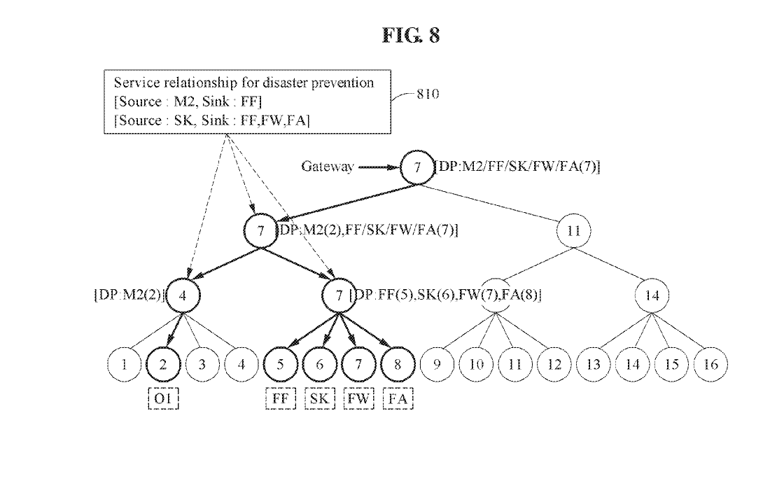

FIG. 8 illustrates a process of transmitting a sociality profile for an interactive communication service according to an example embodiment.

As illustrated in FIG. 8, a gateway notified of service subscription information from objects in a WSN transmits a sociality profile of a particular service to objects associated with the service. In FIG. 8, service relationship information for a disaster prevention service may be acquired based on a sociality profile for the disaster prevention service and be transmitted to all of sensors at nodes 2, 5, 6, 7 and 8 participating in the disaster prevention service through a reverse path of the path for the service subscription process according to information on a previous sensor by each service stored by sensors in the foregoing service subscription process.

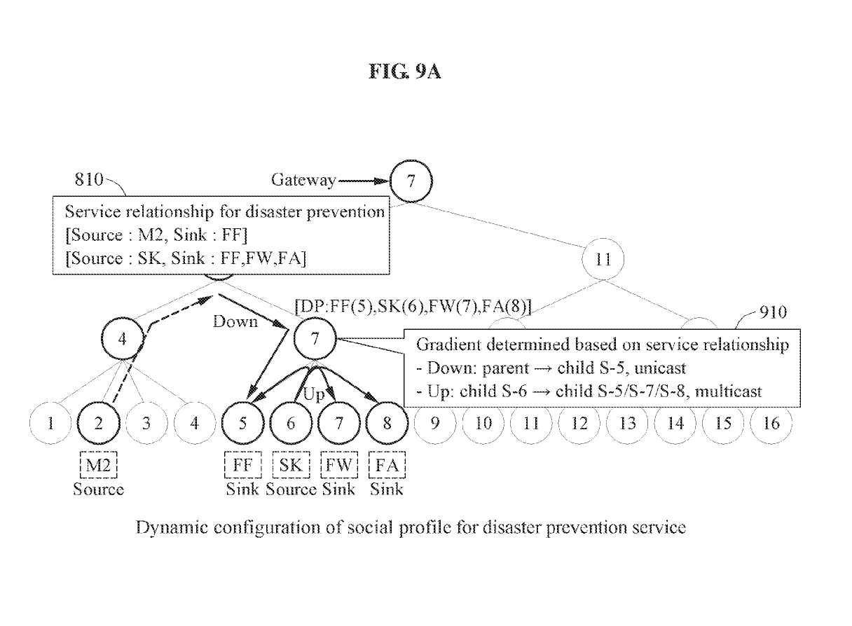

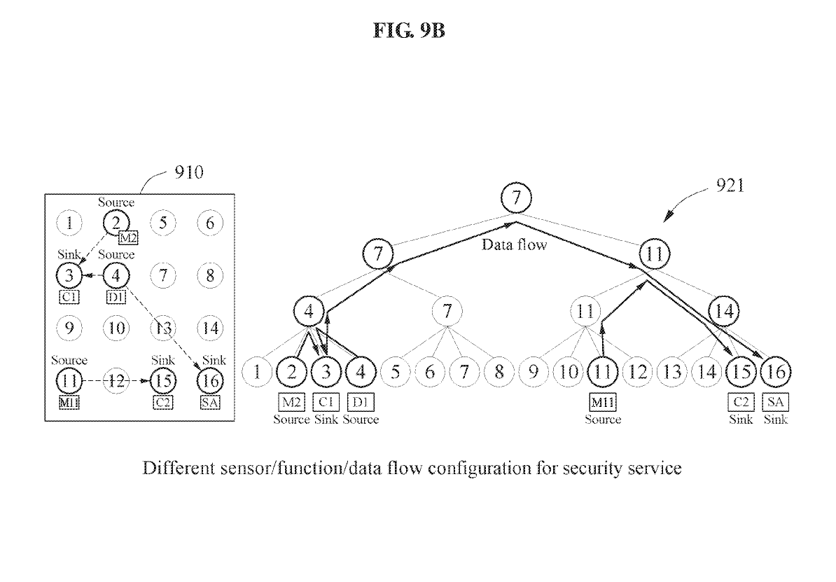

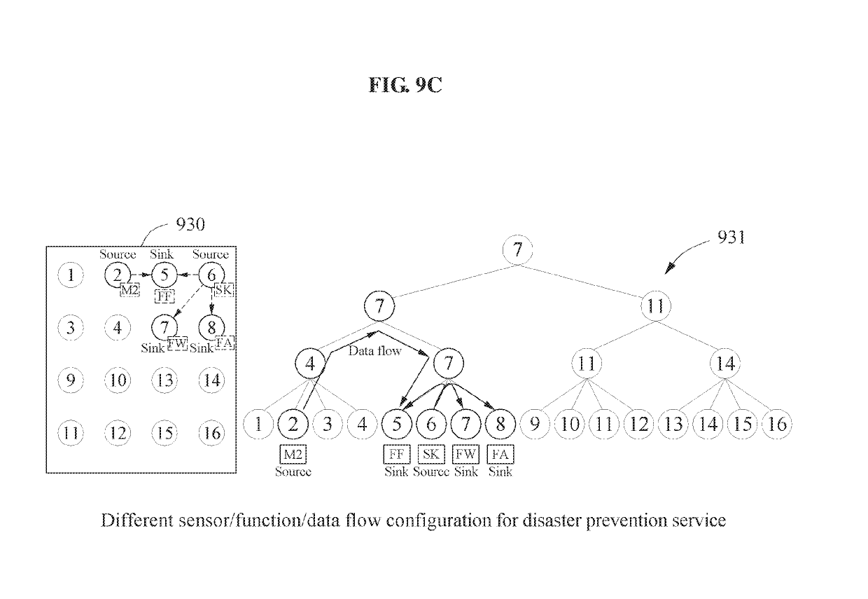

FIGS. 9A to 9C illustrate a social gradient binding process for an interactive communication service according to an example embodiment.

First, FIG. 9A illustrates a gradient binding process for transmitting data in a WSN by node 7 receiving a sociality profile for a disaster prevention service from a gateway. In FIG. 9A, according to a first relationship, when motion sensor M2 at node 2 detects a movement of a survivor, motion sensor M2 needs to transmit such information to firefight FF connected to node 5. In this case, since node 2 is not subordinate to node 7 in a tree structure, node 7 determines that node 2 is present at a parent node and recognizes that node 5 is subordinate to node 7 in the tree structure. Accordingly, node 7 may set up a gradient for sensing data M2 at node 2 to be transmitted from the parent node to node 5. In FIG. 9A, according to a second relationship, when sprinkler SK at node 6 detects fire smoke, sprinkler SK needs to transmit data to firefighter FF at node 5, firewall FW at node 7, and fire alarm FA at node 8. In this case, node 7 recognizes that nodes 5, 6, 7, and 8 are subordinate to node 7 in the tree structure and sets up a gradient for sensing data SK at node 6 to be multicast from node 6 to nodes 5, 7, and 8. Functions of sensors and data flows determined for each service according to a gradient setting result may be illustrated in FIGS. 9B and 9C.

FIG. 9B illustrates a result of generating a gradient of objects for providing a security service, in which nodes 2, 3, 4, 7, 11, 14, 15, and 16 are selected in one physical WSN, nodes 2, 4, and 11 functioning as source nodes and nodes 3, 15, and 16 functioning as sink nodes. Based on a data transmission direction between nodes determined in this manner, a social WSN for the security service is automatically configured.

FIG. 9C illustrates a result of generating a gradient of objects for providing a disaster prevention service, in which nodes 2, 4, 5, 6, and 7 are selected in one physical WSN, nodes 2 and 6 functioning as source nodes and nodes 4, 5, 7, and 8 functioning as sink nodes. Based on a data transmission direction between nodes determined in this manner, a social WSN for the disaster prevention service is automatically configured. As illustrated in FIGS. 9B and 9C, two social WSNs may be automatically and dynamically configured to provide two independent services in one physical WSN.

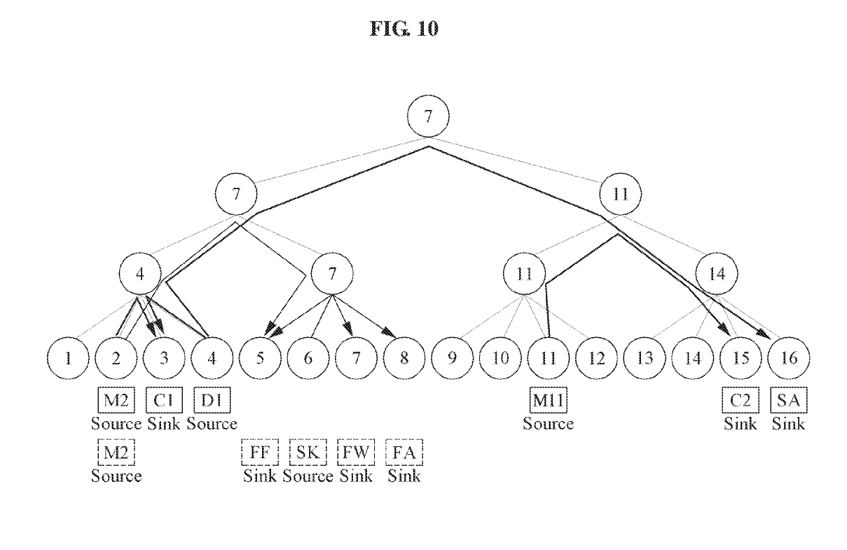

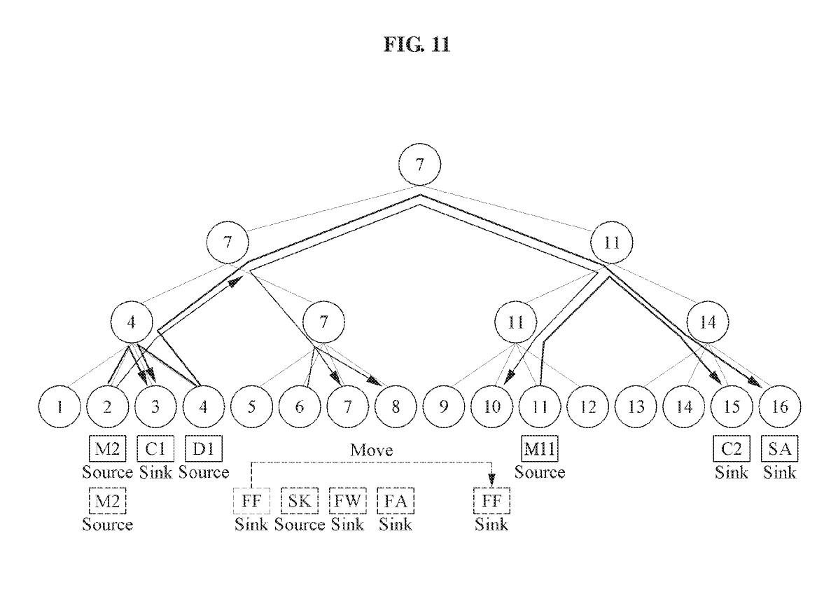

FIG. 10 illustrates a configuration of a social WSN for providing a plurality of interactive communication services according to an example embodiment.

To independently provide a security service and a disaster prevention service in one physical WSN, two independent social WSNs may be configured based on the data transmission directions between the nodes determined in FIGS. 9B and 9C.

In FIG. 10, one multicast data to be transmitted from sprinkler SK at node 6 to firefighter FF at node 5, firewall FW at node 7, and fire alarm FA at node 8 in association with the disaster prevention service needs to be processed as three pieces of unicast data respectively transmitted from sprinkler SK at node 6 to firefighter FF at node 5, from sprinkler SK at node 6 to firewall FW at node 7, and from sprinkler SK at node 6 to fire alarm FA at node 8 in the physical WSN where data is actually transmitted. Accordingly, when sprinkler data is received from node 6, node 7 may generate and transmit three pieces of data to nodes 5, 7, and 8.

FIG. 11 illustrates a process of dynamically configuring a social WSN for supporting mobility for each node according to an example embodiment.

In a disaster prevention service, when a firefight FF moves to extinguish a fire, node 5 recognizes leaving of the firefighter and node 10 recognizes joining of the firefight. Accordingly, a new service subscription process of the firefighter FF is performed again via nodes 10, 11, and 7. According to the new service subscription process, a gateway receiving new service subscription information updates and transmits service relationship information to the network, and a data gradient for the disaster prevention service is also automatically changed according to a changed firefighter position.

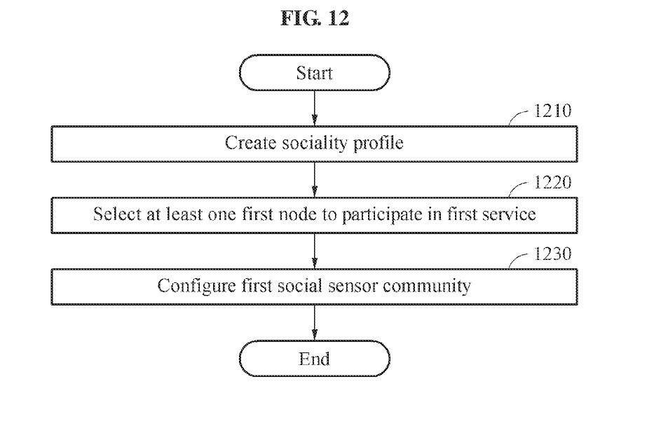

FIG. 12 is a flowchart illustrating a method of providing an interactive communication service according to an example embodiment.

In operation 1210, the creator 110 may create a sociality profile including inter-node relationship information for a first service provided through the sensor network including a plurality of nodes. Here, the sociality profile may include at least one of a first identification code for at least one node needed to provide the first service, source-sink type information, a data transmission relationship, and a second identification code for the first service.

In operation 1210, the manager manages service information on the plurality of nodes included in a sensor network. The service information may include at least one of kinds, locations, network connection relationships and associated service lists of the plurality of nodes included in the sensor network. The manager may periodically notify a gateway in the sensor network of the first identification code for the at least one node associated with the first service and the second identification code for the first service based on the service information. Here, the first identification code may denote an ID of a node (node ID) associated with the first service among the plurality of nodes included in the sensor network and the second identification code may denote a service ID to identify the first service.

In operation 1220, the select 120 may select at least one first node to participate in the first service among the plurality of nodes based on the sociality profile. The selector 120 selects the first node providing the first service using the service information on each node identified through the manager and the sociality profile.

In operation 1230, the setter 130 may establish a data transmission relationship based on a kind and function of the at least one first node and form a first social service group including the at least one first node performing the first service based on the established data transmission relationship. In operation 1230, the setter 130 may store a first path for notifying the gateway of the first identification code and the second identification code and transmit the sociality profile to the first node through a second path that is a reverse path of the first path. Further, the setter 130 may generate a gradient representing a data transmission relationship and interactive relationship between the first nodes based on the source-sink type information included in the sociality profile.

In operation 1230, the setter 130 updates the sociality profile when at least one node is added to or leaves the first social service group. As a result, when all nodes leave the first social service group so that there is no node left, the setter 130 removes the first social service group.

The first social service group supports data transmission between the first nodes using at least one communication mode among a unicast mode, a multicast mode, and a broadcast mode, thereby providing the first service in the sensor network.

The example embodiments described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter. The described hardware devices may be configured to act as one or more software modules in order to perform the operations of the above-described example embodiments, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits are combined or coupled in different forms and modes than as described above or be substituted or switched with other components or equivalents.

Thus, other implementations, alternative embodiments and equivalents to the claimed subject matter are construed as being within the appended claims.

What is claimed is:

1. An apparatus for providing an interactive communication service, the apparatus comprising:
a creator configured to create a sociality profile comprising inter-node relationship information for a first service provided through a sensor network comprising a plurality of nodes;
a selector configured to select at least one first node to participate in the first service among the plurality of nodes based on the sociality profile; and
a setter configured to establish a data transmission relationship based on a kind and function of the at least one first node and to form a first social service group comprising the at least one first node performing the first service based on the established data transmission relationship.

2. The apparatus of claim 1, further comprising a manager configured to manage service information on the plurality of nodes.

3. The apparatus of claim 2, wherein the service information comprises at least one of kinds, locations, network connection relationships, and associated service lists of the plurality of nodes comprised in the sensor network.

4. The apparatus of claim 3, wherein the manager periodically notifies a gateway in the sensor network of a first identification code for at least one node associated with the first service and a second identification code for the first service based on the service information.

5. The apparatus of claim 4, wherein the setter stores a first path for the manager to notify the gateway of the first identification code and the second identification code and transmits the sociality profile to the first node through a second path that is a reverse path of the first path.

6. The apparatus of claim 1, wherein the sociality profile comprises at least one of a first identification code for at least one node necessary for the first service, source-sink type information, a data transmission relationship, and a second identification code for the first service.

7. The apparatus of claim 6, wherein the setter generates a gradient representing a data transmission relationship between the first nodes based on the source-sink type information comprised in the sociality profile.

8. The apparatus of claim 1, wherein the setter updates the sociality profile when at least one node is added to or leaves the first social service group.

9. The apparatus of claim 8, wherein the setter removes the first social service group when all nodes in the first social service group leave the first social service group as a result of updating.

10. The apparatus of claim 1, wherein the first social service group supports data transmission between the first nodes using at least one of a unicast mode, a multicast mode, and a broadcast mode.

11. An apparatus for providing an interactive communication service, the apparatus comprising:
a manager configured to manage service information on at least one of a plurality of nodes comprised in a sensor network;
a creator configured to create a sociality profile of a first service to be provided through the sensor network;
a selector configured to select at least one first node to participate in the first service among the plurality of nodes based on the sociality profile; and
a setter configured to establish a data transmission relationship based on a kind and function of the at least one first node and to form a first social service group comprising the at least one first node performing the first service based on the established data transmission relationship.

12. The apparatus of claim 11, wherein the service information comprises at least one of kinds, locations, network connection relationships, and associated service lists of the plurality of nodes comprised in the sensor network, and the manager periodically notifies a gateway in the sensor network of a first identification code for at least one node associated with the first service and a second identification code for the first service based on the service information.

13. The apparatus of claim 12, wherein the setter stores a first path for the manager to notify the gateway of the first identification code and the second identification code and transmits the sociality profile to the first node through a second path that is a reverse path of the first path.

14. A method of providing an interactive communication service through a sensor network comprising a plurality of nodes by an interactive communication service providing apparatus, the method comprising:
creating, by a creator, a sociality profile comprising inter-node relationship information for a first service provided through the sensor network;
selecting, by a selector, at least one first node to participate in the first service among the plurality of nodes based on the sociality profile; and
establishing, by a setter, a data transmission relationship based on a kind and function of the at least one first node and forming a first social service group comprising the at least one first node performing the first service based on the established data transmission relationship.

15. The method of claim 14, wherein the crating of the sociality profile comprises
managing service information comprising at least one of kinds, locations, network connection relationships, and associated service lists of the plurality of nodes comprised in the sensor network, and
periodically notifying a gateway in the sensor network of a first identification code for at least one node associated with the first service and a second identification code for the first service based on the service information.

16. The method of claim 15, wherein the forming of the first social service group comprises storing, by the setter, a first path for notifying the gateway of the first identification code and the second identification code and transmitting the sociality profile to the first node through a second path that is a reverse path of the first path.

17. The method of claim 16, wherein the sociality profile comprises at least one of a first identification code for at least one node necessary for the first service, source-sink type information, a data transmission relationship, and a second identification code for the first service.

18. The method of claim 17, wherein the forming of the first social service group comprises generating a gradient representing a data transmission relationship between the first nodes based on the source-sink type information comprised in the sociality profile.

19. The method of claim 14, wherein the forming of the first social service group comprises
updating the sociality profile when at least one node is added to or leaves the first social service group, and
removing the first social service group when all nodes in the first social service group leave the first social service group as a result of updating.

20. The method of claim 14, wherein the first social service group supports data transmission between the first nodes using at least one of a unicast mode, a multicast mode, and a broadcast mode.
